(19) United States
(12) Patent Application Publication
(10) Pub. No.: US 2005/0069172 A1
(43) Pub. Date: Mar. 31, 2005

(54) Index identifying method and system

(75) Inventor: Shinji Uchiyama, Kanagawa (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/940,286

(22) Filed: Sep. 13, 2004

(30) Foreign Application Priority Data
Sep. 30, 2003 (JP) 2003-341622

(51) Int. Cl. G06K 9/00; G06K 9/36

(52) U.S. Cl. 382/100; 382/286

(57) ABSTRACT

To easily and accurately identify a rotationally symmetric index, the index disposed in real space is detected in an image captured by a camera and the position of the index in the image is determined. At the same time, the index is projected on a projection plane of the camera based on the position and orientation of the camera and the position of the index. Then, the corresponding detected index and projected index are identified based on the distance between the detected index and the projected index on the captured image and the outer shape.

### CROSS REFERENCE TO RELATED APPLICATIONS

This application claims priority from Japanese Patent Application No. 2003-341622 filed Sep. 30, 2003, which is hereby incorporated by reference herein.

### BACKGROUND OF THE INVENTION

1. Field of the Invention

The present invention relates to a technology for detecting and identifying an index in an image captured by an imaging apparatus, wherein the index is disposed in real space or on an object.

2. Description of the Related Art

For example, in a mixed reality system that is capable of displaying an image by merging real space and virtual space, the position and orientation of an imaging apparatus such as a camera (hereinafter, an imaging apparatus may be simply referred to as a ‘camera’) for capturing an image of real space must be measured. A first known method for compensating for a measurement error of a position and orientation sensor, which measures the position and orientation of a camera by using a marker having a known position in real space or a characteristic point (this point and the marker together will be referred to as an ‘index’) having a known position in virtual space is disclosed in Japanese Patent Laid-Open No. 11-084307 or Japanese Patent Laid-Open No. 2000-041173, and “Superior Augmented Reality Registration by Integrating Landmark Tracking and Magnetic Tracking” (A. State, G. Hirota, D. T. Chen, B. Garrett, and M. Livingston. Proc. SIGGRAPH '96, pp. 429-438, July 1996).

In other words, through this first known method, the position and orientation of a camera is estimated by using a position and orientation sensor for measuring the position and orientation of the camera and an index captured by the camera. In such a known method, the centroid of a color region or a concentric circle may be used as an index. In such a case, a plurality of indices is often used. In one way of determining which one of the indices disposed in real space corresponds to the index detected in an image captured by the camera, the relationship between the coordinates of the index detected in the image and the coordinates of the index projected on the image according to the absolute position of the index is measured by the position and orientation sensor.

There is also a second known method for estimating the position and orientation of a camera by using only an index captured by the camera and not using a position and orientation sensor, as disclosed in “An Augmented Reality System and its Calibration based on Marker Tracking” (H. Kato, M. Billinghurst, K. Asano, and K. Tachibana. Transactions of the Virtual Reality Society of Japan, vol. 4, no. 4, pp. 607-616, December 1999) and “Visual Marker Detection and Decoding in AR Systems: A Comparative Study” (X. Zhang, S. Fronz, and N. Navab. Proc. International Symposium on Mixed and Augmented Reality (ISMAR), 2002). In the method disclosed in these documents, the position and orientation of the camera are estimated based on the coordinates of the four vertices of a square index. By using a square index, the orientation (leftward, rightward, upward, and downward directions) of the index cannot be determined from the coordinates of the four vertices since a square has a 90° rotational symmetry around a rotational axis (i.e., the axis that passes through the center point (intersecting point of the diagonal lines) of the square and is perpendicular to the surface of the square). For this reason, a graphical characteristic is further provided inside the square index to determine the orientation (leftward, rightward, upward, and downward directions). When a plurality of indices is used, the index captured by a camera has to be determined based on only the image captured by the camera. For this reason, unique graphical data, such as a pattern or a symbol, is embedded in each index.

When estimating the position and orientation of the camera according to the first known method, the data provided by one index is merely one coordinate value if a point marker or a concentric circular marker is used. Since the index provides only a small amount of geometric data, a relatively large number of indices are used simultaneously to estimate the position and orientation accurately and to acquire a wide field of view for observation.

As described above, when a plurality of indices is used simultaneously, it is difficult to identify which of the indices in real space correspond to the index captured in an image. In particular, the identification may fail when the graphical characteristics (characteristics such as color and shape that can be identified through image processing) of the indices are identical or similar and when there are a large number of indices disposed.

By applying an index that is graphically more complex, such as the square marker used in the second known method, to the first known method, a smaller number of indices is required since each index includes a plurality of coordinate values (for example, the coordinate values of the center point and the vertices). The square index according to the second known method, however, must include other graphical characteristics (in addition to the shape of the index being a square) inside or in the vicinity of the square so that orientation of the square can be identified.

When two or more square markers are simultaneously used according to the second known method, each marker must be identified by using only the captured image. Therefore, code data unique for each marker or marker data that can be used as a template for distinguishing between each marker must be embedded in each marker. FIGS. 9A to 9C illustrate the details of square indices disclosed in the documents disclosing the second known method. When using such a square index, the index cannot be identified accurately unless the proportion of the size of the captured image of the index in the projection plane is relatively large since the structure of the index is complex. In other words, when using such a square index, a large area in real space is occupied by the index and/or the camera must be disposed close to the index. Hence, strict limitations are posed on the flexibility in the arrangement of the indices.

### SUMMARY OF THE INVENTION

The present invention provides a known index identifying system.

According to an aspect of the present invention, an index identification method includes: capturing, by an imaging apparatus, an image of real space including a real index having a rotationally symmetric outer shape disposed on a real object; acquiring data on the three-dimensional position and orientation of at least one of the imaging apparatus and the real object; detecting a detected index included in the captured image; calculating coordinates of a projected index based on the acquired three-dimensional position and orientation and the data on the position of the detected index; and identifying the detected index based on data on the position and the outer shape of the detected index and the data on the position and shape of the projected index.

According to another aspect of the present invention, an index identification system includes: an image capturing unit adapted to capture, by an imaging apparatus, an image of real space including a real index having a rotationally symmetric outer shape disposed on a real object; a position and orientation measuring unit adapted to acquire data on a three-dimensional position and orientation of at least one of the imaging apparatus and the real object; an index detecting unit adapted to detect a detected index included in the captured image; a projected index coordinate calculation unit adapted to calculate coordinates of a projected index based on the acquired three-dimensional position and orientation and the data on the position of the detected index; and an index identification unit adapted to identify the detected index based on data on the position and the outer shape of the detected index and the data on the position and shape of the projected index.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram of the functional structure of an index identifying system according to a first embodiment of the present invention.

FIG. 2 is a schematic view of the index identifying system according to the first embodiment in use.

FIG. 3 is a schematic view of an index captured in an image.

FIG. 4 is a flow chart of the process carried out by the index identifying system according to the first embodiment.

FIG. 5 is a schematic view of a projected image of a square index according to the first embodiment in an image and a captured image of the square index according to the first embodiment.

FIG. 6 is a conceptual schematic view of a method for identifying the vertices of a square index detected in an image by using the projected square index and the detected square index.

FIG. 7 is a schematic view illustrating, in detail, the method for identifying the vertices of the projected square index and the detected square index.

FIG. 8 is a schematic view of an index identifying system according to a second embodiment in use.

FIG. 9 illustrates examples of indices used for a known method.

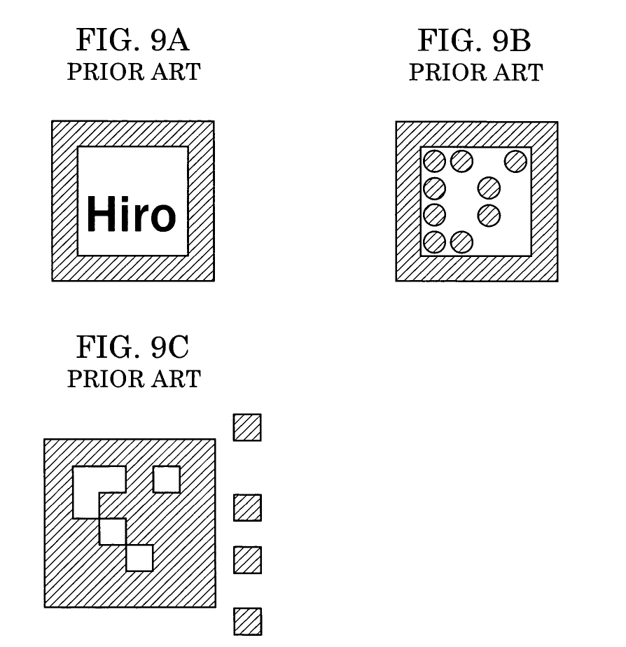

FIG. 10 illustrates a square index according to embodiments of the present invention.

FIG. 11 illustrates other indices according to embodiments of the present invention.

### DESCRIPTION OF THE EMBODIMENTS

Exemplary embodiments of the present invention are described in detail below by referring to the attached drawings.

### First Embodiment

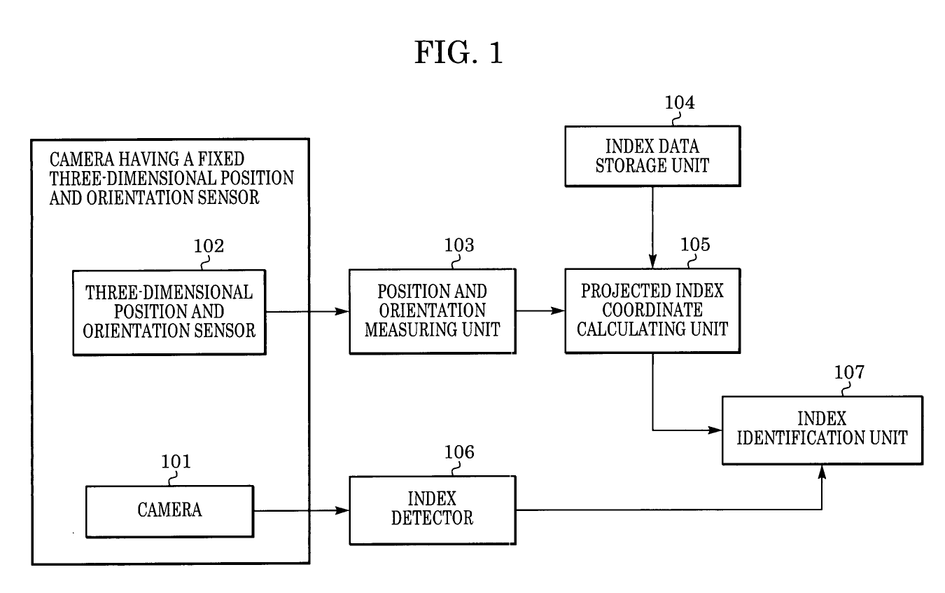

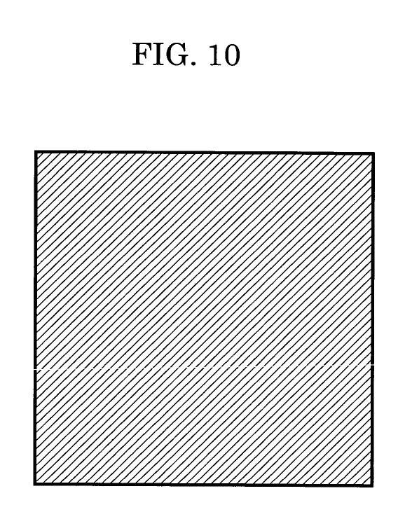

FIG. 1 is a block diagram of the structure of an index identifying system according to a first embodiment. In this embodiment, a simple square, such as that illustrated in FIG. 10, will be used as a preferable index.

A camera 101 used for capturing real space may be, for example, a video camera including an imaging element such as a charge-coupled device (CCD) or a complementary metal oxide semiconductor (CMOS) sensor. The camera 101 has a fixed three-dimensional position and orientation sensor 102 including, for example, a magnetic sensor. A position and orientation measuring unit 103 drives and controls the three-dimensional position and orientation sensor 102 and measures the position and orientation of the camera 101.

An index data storage unit 104 stores in advance data, such as the position (for example, the three-dimensional absolute coordinates of the central point of the index), the three-dimensional absolute coordinates of the vertices, and the size of each index (each square index according to this embodiment) required for identifying the index. The data items described above are only examples; depending on the index and the index identifying method to be used, more or less data items may be stored.

The position and orientation measuring unit 103 supplies data on the position and orientation of the camera 101 obtained by the three-dimensional position and orientation sensor 102 to a projected index coordinate calculating unit 105. The projected index coordinate calculating unit 105 calculates the position of an index projected on a projection plane of the camera 101, which is the index inferred to be captured by the camera 101, based on the position and orientation of the camera 101 and the three-dimensional coordinate data of square indices stored in the index data storage unit 104. Hereinafter, the index captured by the camera 101 and projected on a projection plane of the camera 101 will be referred to as a ‘projected index.’

An index detector 106 detects a region in an image captured the camera 101 that is inferred to be the index based on predetermined data on the index, such as color and shape (hereinafter this index is referred to as a ‘detected index’). An index identification unit 107 identifies an index based on the position and the outer shape of the projected index obtained by the projected index coordinate calculating unit 105 and the projected position and the outer shape of the detected index obtained by the index detector 106.

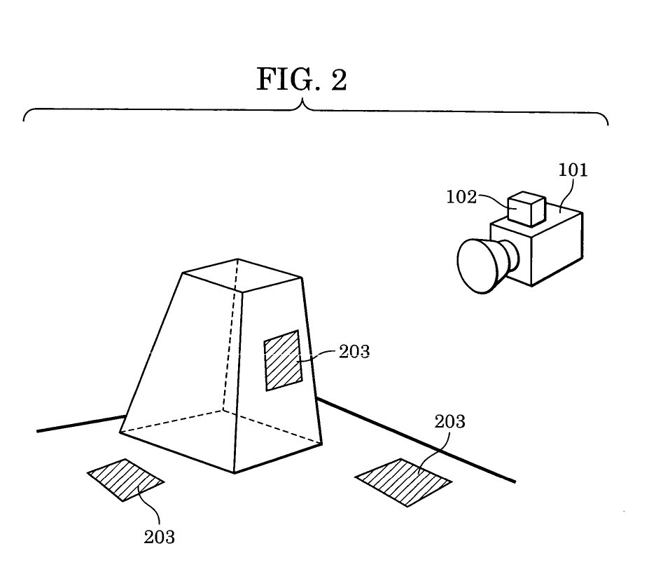

FIG. 2 is a schematic view of an expected operational condition of the index identifying system having the structure illustrated in FIG. 1. Square indices 203 are disposed in real space as depicted in the drawing. Data on the size and position of the indices is stored in the index data storage unit 104.

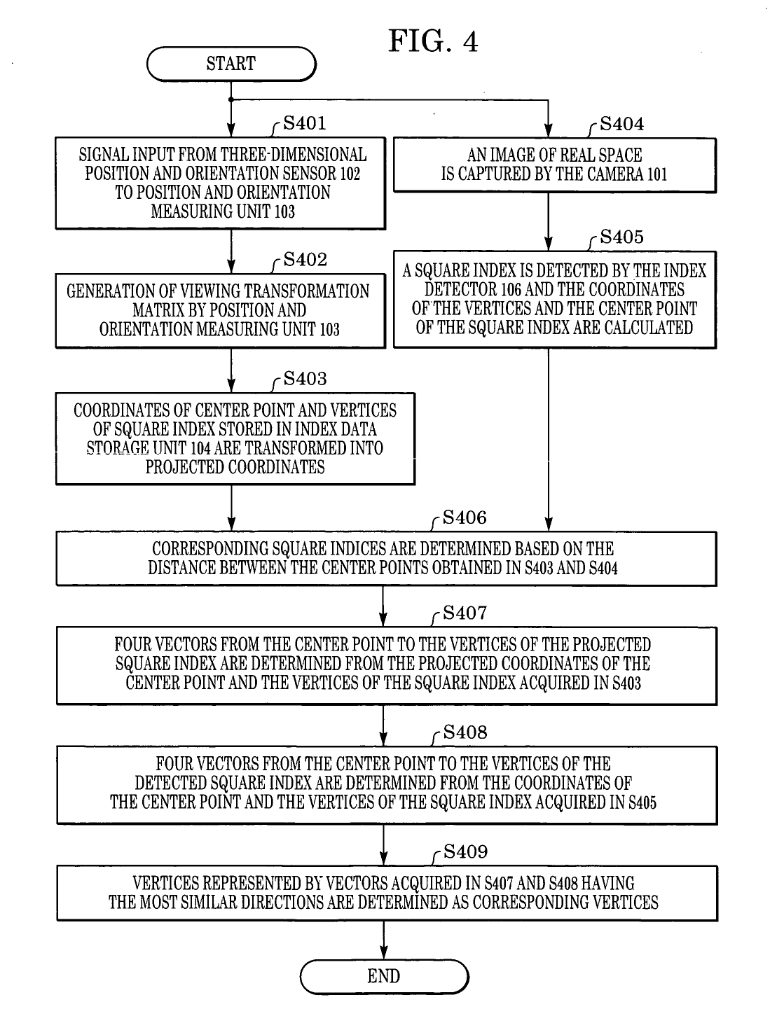

In the following, the process carried out by the index identifying system having the above-described structure will be described by referring to the flow chart in FIG. 4.

In Step S401, the position and orientation of the camera 101 are measured by the three-dimensional position and orientation sensor 102, and this data is sent to the position and orientation measuring unit 103. In Step S402, a transformation matrix for viewing transformation is obtained based on the data acquired in Step 401. In viewing transformation, a world coordinate system, which is a fixed coordinate system in real space, is transformed into a camera coordinate system, which is a three dimensional coordinate system including an origin (eye position of the camera), an xy plane (projection plane of the camera), and a vector extending along the z axis in the negative direction (line of sight of the camera). In other words, in viewing transformation, the coordinates of a point in the world coordinate system is transformed by the position and orientation measuring unit 103 into coordinates in the camera coordinate system. By acquiring a viewing transformation matrix, a coordinate value in the world coordinate system can be easily transformed into a coordinate value in the camera coordinate system.

In Step S403, the positions (coordinates) of the center point and the vertices of a square index stored in the index data storage unit 104 are transformed by the projected coordinate calculating unit 105 into coordinates of a camera coordinate system by using the viewing transformation matrix obtained in Step S402. Then, by calculating the perspective projection transformation of the camera 101, the estimated positions (coordinates) of the center point and the vertices of the square index projected on the projection plane is determined. The perspective projection transformation of the camera 101 is uniquely determined by the focal distance of the lens and the position of the principal point (projection center) of the camera 101. The perspective projection transformation may be determined in advance.

While proceeding through Steps S401, S402, and S403, the camera 101 captures an image of real space in Step S404. Then, in Step S405, the square index in the captured image is detected by the index detector 106. The square index may be detected by any method including, for example, the method described below.

By setting the brightness of the index at a value different from the background, image of the index is polarized according to brightness. Then, through a labeling process, the continuous region in the image is determined. The outline of the square index is detected by applying broken-line approximation to the labeled periphery of the continuous region. The vertices of the detected square index are determined. Subsequently, by determining the intersecting point of the diagonal lines, the center point of the square index is determined.

Through the above-described steps, the coordinates of the vertices and the center point of the projected square index projected and the coordinates of the vertices and the center point of the detected square index (the index displayed in the image appears as a quadrangle and not a square) are obtained.

Next, the square index and its rotational symmetry are identified. In other words, it is determined which index among the indices in real space is the detected index and, furthermore, the orientation of the square index is determined. In Step S406, the index identification unit 107 compares the coordinates of the center point of the projected square index obtained in Step S403 (by the projected index coordinate calculating unit 105) with the coordinates of the center point of the detected square obtained in Step S405 (by the index detector 106). Then, the projected index and the detected index within the closest distance to each other are determined as corresponding square indices. Step S406 is for identifying a square index when a plurality of square indices exists. If there is only one square index, Step S406 is omitted.

The steps below are for identifying an index by comparing the outer shapes of the projected index obtained in Step S403 and the detected index obtained in Step S405. Since, in this embodiment, the index is a regular square, the outer shape can be compared by comparing the directions of the vectors from the center point to each vertex. The comparison process is described below.

In Step S407, four vectors from the center point to the four vertices of the projected square index, whose coordinates were determined in Step S403, are obtained. Then, in Step S408, four vectors from the center point to the four vertices of the detected square index, whose coordinates were determined in Step S405, are obtained.

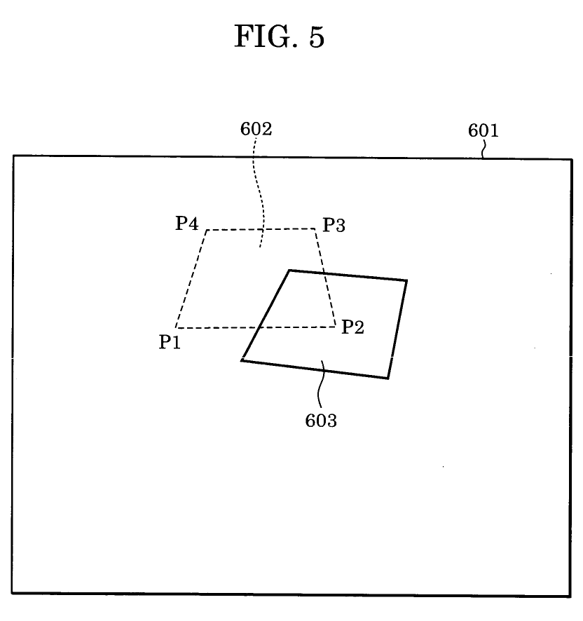

Steps S407 and S408 are described next with reference to FIG. 5. The coordinates obtained in Step S403 of an index inferred to be disposed in the field of view of the camera 101, are projected on a projection plane 601 of the camera 101 as a projected square index 602, as illustrated in FIG. 5. The index 602 corresponds to a detected square index 603, which is detected in an image captured by the camera 101.

The index data storage unit 104 stores data about individual vertices of a square index. Therefore, it is apparent that the vertices in the projected coordinate obtained by projecting the original vertices of the square index on the projection plane 601 correspond to the respective original vertices.

FIG. 5 illustrates a schematic view of vertices P1, P2, P3, and P4 of the projected square index 602. The vertices of the detected square index 603 corresponding to the vertices P1, P2, P3, and P4 of the projected square index 602 are unknown since the detected square index 603 does not have directionality and has rotational symmetry around its center point.

Steps S407 and S408 are preliminary steps for determining the corresponding vertices of the projected square index 602 and detected square index 603, respectively. In Steps S407 and S408, vectors from the center point of the square index to the vertices are obtained for the projected square index 602 and detected square index 603, respectively. In Step S409, the vectors obtained in Steps S407 and S408 are compared to determine a pair of vectors of the square indices 602 and 603 having the closest direction as a pair of corresponding vectors. In this way, the vertices of the projected square index 602 are associated with the vertices of the detected square index 603.

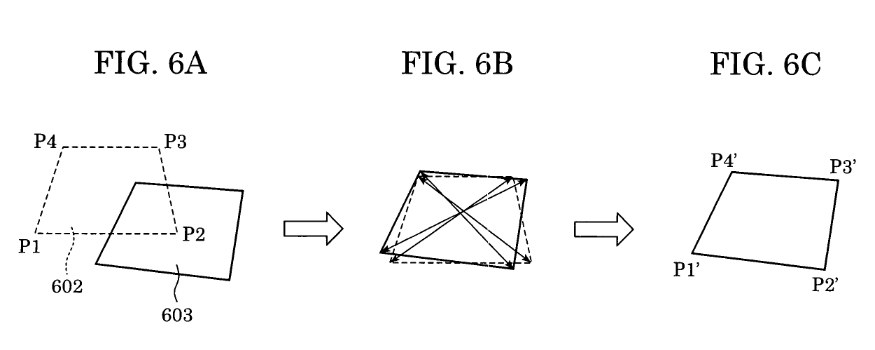

The processing carried out in Step S409 is described in further detail next with reference to FIG. 6. FIG. 6A illustrates the projected square index 602, which is projected on the projection plane 601, and the square index 603, which is detected from the image captured by the camera 101. Although not illustrated in the drawing, the vectors from the center point to the vertices for each of the square indices 602 and 603 are already obtained in Steps S407 and S408.

In Step S409, as illustrated in FIG. 6B, the directions of each of the vectors of the square indices 602 and 603 are compared by matching the origins of the vectors (the center points of the square indices 602 and 603) without rotating the square indices 602 and 603. The pair of vectors having the most similar directions is determined as a pair of corresponding vectors. In other words, the vertices represented by the vectors having the most similar directions are determined as corresponding vertices. In this way, as illustrated in FIG. 6C, the vertices of the detected square index 603 can be identified. Vertices P1′, P2′, P3′, and P4′ in FIG. 6C represent the results of the identification: the vertices P1, P2, P3, and P4 of the projected square index 602 are identified as corresponding to the vertices P1′, P2′, P3′, and P4′ of the detected square index 603, respectively.

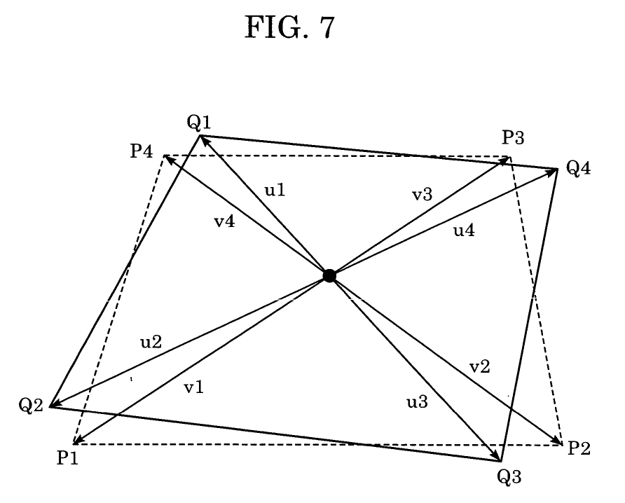

The above-described process is described in more detail by referring to FIG. 7, which illustrates FIG. 6B in more detail. Vectors v1, v2, v3, and v4 are directed from the center point to the vertices of the projected square index 602. Vectors u1, u2, u3, and u4 are directed from the center point to the vertices of the detected square index 603. The corresponding vertices of the square indices 602 and 603 are determined by defining four pairs of vectors forming the smallest angle by one of the vectors v1, v2, v3, and v4 and one of the vectors u1, u2, u3, and u4 (i.e., a pair of vectors having the most similar direction). If the angle formed by a vector vᵢ and a vector uⱼ is θ_{i,j}, θ_{i,j} is defined using the following equation:

$${θ}_{i , j} = {cos}^{- 1} \frac{{v}_{i} \cdot {u}_{j}}{\vert {v}_{i} \vert \vert {u}_{j} \vert} \qquad ( 1 )$$

There are four possible pairs of vectors, and the sum of the angles formed by these pairs of vectors can be obtained by the four formulas below:
Θ₁=θ_{1,1}+θ_{2,2}+θ_{3,3}+θ_{4,4}
Θ₂=θ_{1,2}+θ_{2,3}+θ_{3,4}+θ_{4,1}
Θ₃=θ_{1,3}+θ_{2,4}+θ_{3,1}+θ_{4,2}
Θ₄=θ_{1,4}+θ_{2,1}+θ_{3,2}+θ_{4,1}

In other words, either Θ₁, Θ₂, Θ₃, or Θ₄ having the smallest value represents the pairs of vectors having the most similar directions. Since, in FIG. 7, Θ₂ (the sum of pairs of vectors v1 and u2, v2 and u3, v3 and u4, and v4 and u1) has the smallest value, the vertices P1′, P2′, P3′, and P4′, illustrated in FIG. 6C, are determined to be corresponding to the vertices P1, P2, P3, and P4, respectively.

In the above-described method, the corresponding vertices are determined by obtaining the sum of the angles formed by the vectors. The corresponding vertices, however, can be determined by the average angle of the vectors, instead of the sum of the angles, or any other method based on the angles formed by the vectors as long as the corresponding vertices can be determined by the method. The similarity of the directions of the vectors can be directly compared by the scalar product, instead of the angles.

Steps S407 to S409 determine the corresponding vertices of the square indices 602 and 603. In addition to the method described in Steps S407 to S409, other methods, such as the one described below, may be used. This method compares the distances between vertices Q1, Q2, Q3, and Q4 of the square index 603 and the vertices P1, P2, P3, and P4 of the square index 602 after matching the center points of the square indices 602 and 603 without rotating them, as illustrated in FIG. 7. Similar to the calculations for comparing the angles formed by the vectors, the distances between the four possible pairs of and the sum of the distances between the vertices can be obtained by the four formulas below, (where the distance from a vertex Pᵢ to a vertex Qᵢ is l_{i,j}). Then, the pairs having the smallest sum may be selected.
L₁=l_{1,1}+l_{2,2}+l_{3,3}+l_{4,4}
L₂=l_{1,2}+l_{2,3}+l_{3,4}+l_{2,1}
L₃=l_{1,3}+l_{2,4}+l_{3,1}+l_{4,2}
L₄=l_{1,4}+l_{2,1}+l_{3,2}+l_{4,3}

In such a method using the distance between the vertices, other methods using, for example, the average (instead of the sum) of the distance between the vertices may be applied.

There is also a method in which the directions and/or distances of linear segments representing the sides of the square indices are used. For example, among the linear segments having the most similar directions, the linear segments within the closest distance of each other can be determined as being corresponding linear segments, and, from this, the vertices can be identified. Otherwise, among the linear segments within the closest distance of each other, the linear segments having the most similar directions can be determined as being corresponding linear segments. Moreover, the corresponding linear segments may be determined based on either the distances or the directions of the linear segments. When determining the corresponding linear segments based on the distances and/or the directions of the linear segments, the sum or the average may be used. Hence, as long as the results are optimal, any method may be used to determine the corresponding vertices of the square indices 602 and 603 based on their outer shape.

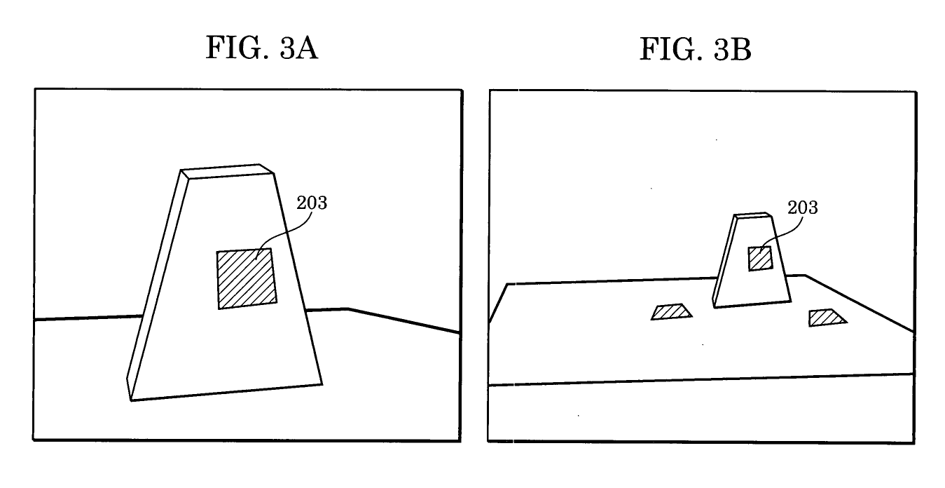

When an index has rotational symmetry, the vertices of the index cannot be identified by merely detecting the index in a captured image. According to this embodiment, however, even for such a case, the vertices of the index can be identified. An index according to this embodiment does not require additional data such as patterns or text for adding directionality or uniqueness to the index. Thus, the index is simple and is easily detectable in a captured image. In other words, not only in a case, for example, where the captured image is sufficiently large, such as in FIG. 3A, but also in a case where the image of the index captured by the camera 101 is small, such as in FIG. 3B, the index can be detected stably. Furthermore, since additional data, such as patterns or text for adding directionality or uniqueness to the index, is unnecessary, the size of the index according to this embodiment can be reduced in comparison to the index according to known methods for estimating the position and orientation of a camera by using only an index captured by the camera and not using a position and orientation sensor. Accordingly, the index can be prepared so that its appearance does not attract too much attention. Moreover, since the size of the captured index does not have to be large, there will be very few restrictions on the positions of the camera and the index.

### Second Embodiment

In the first embodiment, a three-dimensional position and orientation sensor was disposed on a camera. In such a case, the camera was moved to capture an image of an index fixed in real space. The present invention may also be applied in a case where the camera is fixed and a real object having the three-dimensional position and orientation sensor and the index moves.

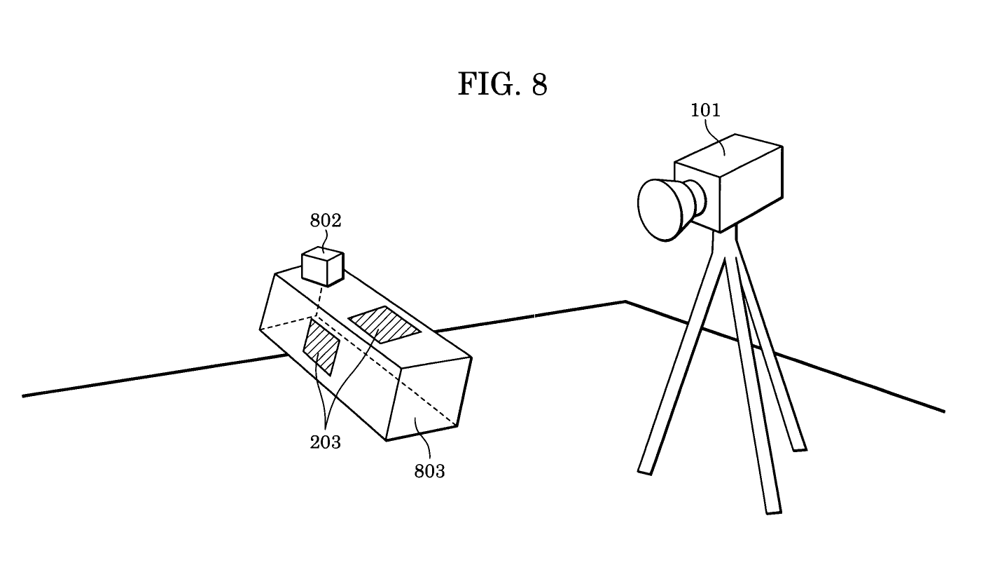

FIG. 8 is a schematic view illustrating the relationship between a camera 101, a real object 803, and a three-dimensional position and orientation sensor 802. An index identifying system according to the second embodiment of the present invention has the same structure as the index identifying system according to the first embodiment illustrated in FIG. 1, except that the three-dimensional position and orientation sensor 802 is disposed on the real object 803 instead of the camera 101.

In this embodiment, instead of acquiring a viewing transformation matrix for transforming a world coordinate system into a camera coordinate system, such as in Step S402 for identification according to the first embodiment illustrated in FIG. 4, a transformation matrix for modeling transformation is obtained based on the measured values of the position and orientation of the real object 803. Modeling transformation transforms coordinates between a world coordinate system, which is a fixed coordinate system in real space, and an object coordinate system, which is a coordinate system fixed to a real object; in modeling transformation, a point in the object coordinate system is transformed into a point in the world coordinate system. In other words, by obtaining a modeling transformation matrix, a coordinate value of a fixed position on a real object can be easily transformed into a coordinate value in the world coordinate system.

In Step S403, the projected index coordinate calculating unit 105 uses the modeling transformation matrix instead of the viewing transformation matrix to project an index 203 on a projection plane of the camera 101. By performing the other steps indicated in FIG. 4 in the same manner as those in the first embodiment, the square index can be identified.

### Third Embodiment

In the first embodiment, the camera was moved and the index was fixed. In the second embodiment, the camera was fixed and the real object including the index was moved. The present invention, however, may also be applied in a case where a camera and a real object including an index are both moved.

In such a case, three-dimensional position sensors are disposed on both the camera and the moving object. Then, from the acquired results, transformation matrices for calculating a projected index are obtained in Step S402. More specifically, transformation matrices for transforming coordinates of a point in the object coordinate system into coordinates in the camera coordinate system through multiple steps are obtained. Where the coordinate system fixed to the moving object is an object coordinate system, the coordinate system fixed to the camera is a camera coordinate system, and the fixed coordinate system in real space is a world coordinate system.

Since this multi-step transformation includes both a modeling transformation for transforming a point in the object coordinate system into the world coordinate system and a viewing transformation for transforming a point in the world coordinate system into the camera coordinate system, the transformation can be easily performed by using the matrices of each transformation.

In Step S403, a projected index is obtained by using this multi-step transformation. Other steps are carried out in the same manner as in the first embodiment.

### Other Embodiments

In the above-described embodiments, an index detecting system having a camera and a three-dimensional position and orientation sensor was described for a better understanding of the present invention. The camera and the three-dimensional position and orientation sensor, however, are not essential for the present invention. The three-dimensional positions and orientations of the camera (according to the first and third embodiments) and the object (according to the second and third embodiments) can be measured by some other apparatus and, similarly, the image of the camera and the object can be captured by another apparatus. Moreover, the identifying process does not have to be carried out in real time and, instead, may be carried out based on stored data of the three-dimensional position and orientation and stored images.

In the above-described embodiments, a square index, such as that illustrated in FIG. 10, is used. The shape of the index, however, is not limited to a square and may be any regular polygon or any shape having rotational symmetry.

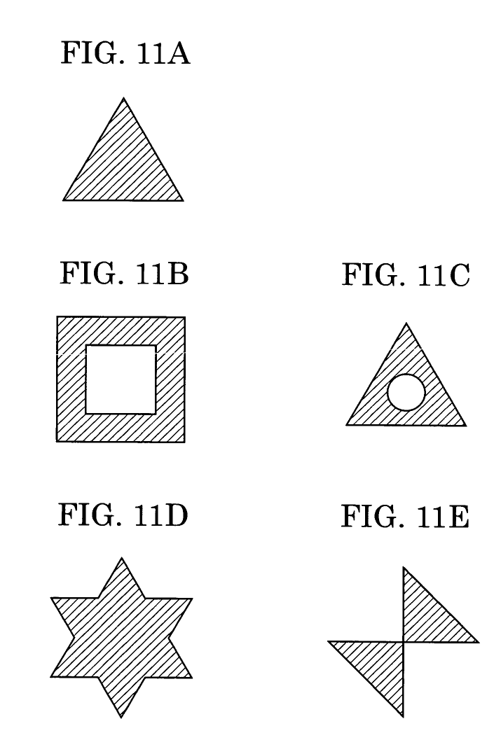

For example, an index shaped as a regular triangle, as illustrated in FIG. 11A, may be used. For such a case, in Step S403, the coordinates of the center point and the three vertices of the projected triangular index are calculated, and, in Step S405, the center point and the three vertices of the detected triangular index are calculated. For a square index, the center point is obtained by determining the intersecting point of the diagonal lines. For a triangular index, the center point is obtained by determining the intersecting point of each straight line from a vertex to the midpoint of the opposing side. The triangular index can be identified through the following steps in the same manner as the above-mentioned embodiments. An index shaped as a regular polygon other than a square or a triangle can also be identified in the same manner.

As the number of vertices of the index increases, the more complicated the identifying process becomes. Moreover, when the projected index and the detected index are rotated relative to each other, the corresponding vectors in each index may not be determined correctly. For these reasons, it is preferable for an index to have fewer vertexes.

As illustrated in FIGS. 11B and 11C, the index may include additional graphical data within its base shape. FIG. 11B illustrates a square index including a concentric square having a different brightness. FIG. 11C illustrates a triangular index including a concentric circle having a different brightness. Such additional graphical data may be used, for example, when the index is detected in a captured image to distinguish the index from other objects naturally existing in real space.

As illustrated in FIGS. 11D and 11E, the index according to the present invention does not have to be a regular polygon and may be any shape having rotational symmetry, having indefinite rotational angles, and being detectable in an image.

Any method, in addition to the above-described method, for comparing the outer shape of an index may be used. Moreover, a plurality of methods may be combined. For example, the vectors from the center point to the vertices of an index having a shape as illustrated in FIG. 11D have two different magnitudes. Thus, when detecting the directions of the vectors, vectors having the same magnitude can be compared to improve the accuracy of the identification process.

The present invention may also include a plurality of apparatuses realizing the same function as the index identifying system according to the above-described embodiments.

Another aspect of the present invention may be a software program for realizing the same functions as the above-described embodiments, wherein the software program is supplied directly or via wire or wireless communication from a storage medium to a system or apparatus including a computer capable of running the software program.

The program code supplied to and installed in a computer for realizing the functions according to the present invention are also an aspect of the present invention. In other words, the computer program for realizing the functions according to the present invention is an aspect of the present invention.

Any type of program having the above-mentioned functions, such as object code, a program run by an interpreter, or script data supplied to an operating system (OS), may be used.

The recording medium for storing the program may be a flexible disk, a hard disk, a magnetic recording medium, such as a magnetic tape, a optic or magnetic optical recording medium, such as a magneto-optical (MO), a compact disk—read-only memory (CD-ROM), a compact disk—rewritable (CD-RW), a digital versatile disk—read-only memory (DVD-ROM), a digital versatile disk—recordable (DVD-R), or a non-volatile semiconductor memory.

As a method for supplying the program to a computer via wire or wireless communication, a data file stored on a server on a computer network can be downloaded to and run by a client computer connected to a computer network. In this case, the data file may be a data file containing a computer program capable of realizing the functions according to the present invention or a compressed file of the computer program including an automatic install function. In such a case, the program data file can be divided into segment files, and these segment files can be stored on different servers.

A server may allow a plurality of users to download the program data file on a computer for realizing the functions according to the present invention.

A program according to the present invention may be encrypted and stored on a recording medium, such as a CD-ROM, and then distributed to a user. The key for decoding the stored program may be provided to the user, who satisfies a predetermined condition, through the Internet (in other words, the user may download the key from a predetermined web site). The user can use the key to decode the program so that the program can be installed and run on a computer.

The functions according to the above-described embodiments may be realized by a computer capable of reading and running a program. In addition, the functions according to the above-described embodiments may be realized by an OS running on a computer, wherein the OS entirely or partially performs the processing commanded by the program.

The functions according to the above-described embodiments may also be realized by writing a program read out from a recording medium onto a memory included in a function extension board disposed in a computer or a function extension unit connected to a computer, and then a CPU included in the function extension board or the function extension unit entirely or partially performs the processing according to the program.

Although the present invention has been described in its preferred form with a certain degree of particularity, many apparently widely different embodiments of the invention can be made without departing from the spirit and the scope thereof. It is to be understood that the invention is not limited to the specific embodiments thereof except as defined in the appended claims.

1. A method for identifying a detected index comprising:
capturing, by an imaging apparatus, an image of real space including a real index disposed on a real object;
acquiring data on three-dimensional positions and orientations of at least one of the imaging apparatus and the real object;
detecting a detected index included in the image;
obtaining a projected index by projecting the detected index on a projection plane of the imaging apparatus;
calculating coordinates of the projected index based on the data on the three-dimensional positions and orientations and data on a position of the detected index; and
identifying the detected index based on data on the position and outer shape of the detected index and data on position and outer shape of the projected index.

2. The method according to claim 1, wherein each index has a rotationally symmetric outer shape.

3. The method according to claim 2, wherein the data on the position of each index comprises three-dimensional coordinates of a center point of the index and three-dimensional coordinates of each vertex of the index.

4. The method according to claim 3, wherein identifying the detected index further comprises:
obtaining first vectors from the center point to each vertex of the projected index;
obtaining second vectors from the center point to each vertex of the detected index;
comparing the directions of the first vectors with the directions of the second vectors;
determining pairs comprising a first vector and a second vector having the most similar directions as being corresponding vectors; and
identifying vertices of the detected index corresponding to vertices of the projected index based on the corresponding vectors.

5. The method according to claim 4, wherein the first vectors and the second vectors are compared to each other based on one of the sum, the average, and the scalar product of the angles formed by the first and second vectors.

6. The method according to claim 3, wherein identifying the detected index further comprises:
calculating distances between pairs of vertices, the pairs of vertices each comprising a respective vertex of the projected index and a respective vertex of the detected index; and
determining corresponding vectors as being pairs of vertices within the closest distance of each other among the vertices of the projected index and the vertices of the detected index.

7. The method according to claim 3, wherein identifying the detected index further comprises:
determining pairs of linear segments, each pair of linear segments being within a closest distance among linear segments comprising sides of the projected index and linear segments comprising sides of the detected index based on at least a direction or distance of the linear segments; and
identifying vertices of the detected index corresponding to vertices of the projected index based on the pairs of linear segments, each pair being within the closest distance as determined as being corresponding linear segments.

8. A computer program for commanding a computer to perform the method according to claim 1.

9. A recording medium readable by the computer for storing the computer program according to claim 8.

10. An index identification system comprising:
an image capturing unit adapted to capture, by an imaging apparatus, an image of real space including a real index having a rotationally symmetric outer shape disposed on a real object;
a position and orientation measuring unit adapted to acquire data on a three-dimensional position and orientation of at least one of the imaging apparatus and the real object;
an index detecting unit adapted to detect a detected index included in the image;
a projected index coordinate calculation unit adapted to calculate coordinates of a projected index based on the acquired three-dimensional position and orientation and the data on position of the detected index; and
an index identification unit adapted to identify the detected index based on data on position and outer shape of the detected index and data on position and outer shape of the projected index.

11. The index identification system according to claim 10, wherein the projected index is obtained by projecting the detected index on a projection plane of the imaging apparatus.

12. The index identification system according to claim 10, further comprising a three-dimensional position and orientation measuring unit on at least one of the imaging apparatus and the real object, the three-dimensional position and orientation measuring unit providing data on the three-dimensional position and orientation of the at least one of the imaging apparatus and the real object to the position and orientation measuring unit.
